(19) United States
(12) Patent Application Publication
(10) Pub. No.: US 2005/0185548 A1
(43) Pub. Date: Aug. 25, 2005

(54) Information access control for optical media

(76) Inventors: Charles R. Weirauch, Loveland, CO (US); Edward S. Beeman, Fort Collins, CO (US); Christiaan Steenbergen, Austin, TX (US); Dirk Erickson, Austin, TX (US); Thomas L. Pratt, Austin, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/784,075

(22) Filed: Feb. 19, 2004

(51) Int. Cl. G11B 5/58; G11B 7/24

(52) U.S. Cl. 369/53.2; 369/94

(57) ABSTRACT

A drive refuses to transfer information from a first surface on an optical medium unless required information is present on a second surface of the medium. Optionally, information on the first surface may indicate that information on the second surface is required. For example, a drive may refuse to transfer data from a data surface unless a serial number is readable on an exterior surface.

### BACKGROUND

### TECHNICAL FIELD

The invention relates generally to optical media used for information storage, and drives for reading optical media used for information storage.

In some circumstances, a drive for optical media (for example, optical disks or optical cards) may be designed to deny access to data on an otherwise compatible optical medium. For example, some optical disks with entertainment content have geographic restrictions, and drives sold in a particular geographic region may refuse to read media that is not intended for distribution within that particular geographic region. As another example, for copy protection, a drive may refuse to read data that is on an inappropriate medium. For example, some types of data may exist legitimately only on read-only media, and a drive may refuse access if the data is on a writeable medium.

There is an ongoing need for control of access to information stored on optical media.

### SUMMARY

A drive refuses to transfer information from a first surface on an optical medium unless required information is present on a second surface of the medium.

### BRIEF DESCRIPTION OF THE DRAWINGS

FIG. 1 illustrates an example system in which the invention may be implemented.

FIG. 2 is a plan view of an optical disk illustrated in FIG. 1, with two examples of information on an external surface of the disk.

FIG. 3 is a flow chart of an example method.

### DESCRIPTION

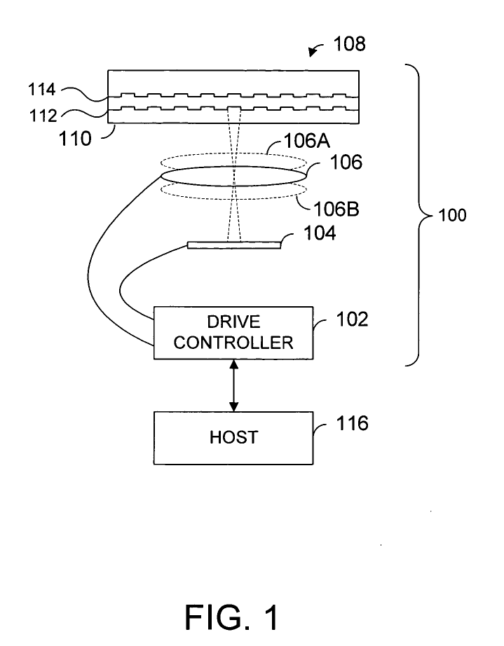

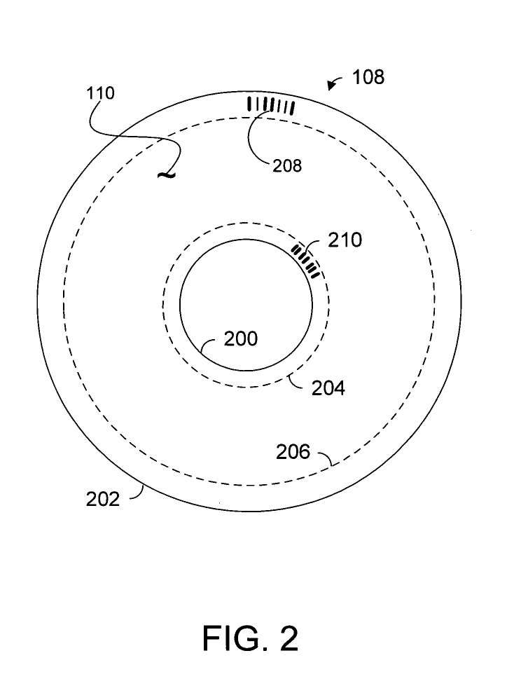

In FIGS. 1 and 2, an optical disk is used as an example. The invention is equally applicable to other optical media, such as optical cards. In FIG. 1, a drive 100 includes a drive controller 102, a photosensor array 104, an objective lens 106, and an optical disk medium 108. The lens focuses laser light reflected from a surface of the optical disk onto the photosensor array. The drive controller receives signals from the photosensor array, and controls the focal point of the lens 106. A host 116 sends data to the drive controller, and receives data from the drive controller. The drive may be part of the host, for example, an internal drive in a computer system or entertainment system. Alternatively, the drive may be peripheral to the host, transferring information via a cable, via a network, or wirelessly.

The optical disk medium in FIG. 1 has a protective outer layer with an external surface 110, and at least one internal data surface (112, 114). If there are multiple data surfaces, then the internal data surface closest to the lens is partially reflective. In FIG. 1, the lens 106 is depicted as having a focal point at internal data surface 112. Reference numbers 106A and 106B depict the lens 106 being positioned at two alternative positions, resulting in the focal point being positioned on internal data surface 114 or (optionally) on the external surface 110, respectively.

For some media, auxiliary information is required to be present, and readable by the drive, in order for data on at least one data surface to be read from the media and sent to a host. When the host 116 requests data from at least one of the interior data surfaces (112, 114) from an optical disk medium that requires the presence of auxiliary information, the drive controller 102 will refuse to provide the requested data to the host unless the drive can read the required auxiliary information on another surface (110, 112, 114). For example, the drive may refuse to externally transfer data from data surface 114 unless required information is present and readable on data surface 112.

The drive may know a priori that auxiliary information is required, or the drive may determine from the medium whether auxiliary information is required. For example, the requirement for auxiliary information may be specified as part of a standard, or may be determined by firmware in the drive controller, or may be specified by information on at least one surface of the medium. As one alternative, the drive may be programmed to always check for the required information when particular media is being read. For example, any time writeable media is being read, the drive may automatically determine whether required auxiliary information is present. Alternatively, information on at least one internal data surface (112, 114) may include an indication that auxiliary information is required to be present on at least one other surface, and the auxiliary information must be readable by the drive. For example, information on internal data surface 112 may indicate that auxiliary information is required to be present on the exterior surface 110, and the auxiliary information on the exterior surface must be readable by the drive. Alternatively, for example, information on internal data surface 112 may indicate that auxiliary information is required to be present on internal data surface 114, and the auxiliary information on the internal data surface 114 must be readable by the drive.

Auxiliary information may be a single symbol, or multiple symbols, or may be data. Likewise, if the requirement for auxiliary information is determined by information on a surface of the medium, the information indicating the requirement for auxiliary information may be a single symbol, or multiple symbols, or may be data. The auxiliary information may, for example, be a symbol representing a geographic region, or may, for example, be data indicating copy control information. The auxiliary information may be identical for all copies of a disk, or the auxiliary information may be variable. For example, the auxiliary information may be a unique serial number for each individual medium. Information that indicates that auxiliary information is required may or may not specify some characteristic of the auxiliary information. For example, presence of a symbol on one surface may indicate that unspecified information must be present on another surface. For example, presence of a symbol may trigger drive controller firmware to look for auxiliary information having a format and location specified in drive controller firmware. Alternatively, for example, information on an inner surface may specify that a specific symbol (for example, a trademark or a company logo) must be present, or may specify that data having specific characteristics must be present (for example, a serial number having a specified number of bits or digits, or a particular checksum of data on a data surface).

FIG. 2 further illustrates the optical disk 108 illustrated in FIG. 1, and illustrates two examples of auxiliary information on the exterior surface 110. The disk has a mounting hole 200 and an outer edge 202. Data on internal surfaces (FIG. 1, 112, 114) resides in an area between an inner diameter 204 and an outer diameter 206. FIG. 2 illustrates two examples of auxiliary information in the form of bar code data (208, 210) on the exterior surface 110. Bar code data 208 is outside the outer diameter 206 of data on an interior surface. Bar code data 210 is inside the inner diameter 204 of data on an interior surface. The format of the bar code data (208, 210) is not important. Bar code data 208 depicts an example of information encoded in the width of bars. Bar code data 210 depicts an example of information encoded in the spacing of bars.

FIG. 2 illustrates auxiliary information encoded in bar codes, but in general the only requirement is information that is readable by the drive. Optically detectable marks or symbols may be implemented in a number of different ways. For example, for the exterior surface, marks or symbols may be affixed to the exterior surface by a label, may be printed (for example, with an ink jet printer or by silk screening) directly onto the exterior surface, may be etched into the exterior surface (chemically, or by use of a high power laser), or a portion of the exterior surface may be coated with a light sensitive material that is then chemically developed after exposure to patterns defining marks or symbols, or a portion of the exterior surface may be coated with an opaque or reflective material and parts of the coating may be removed (for example, chemically, or ablated with a high power laser). U.S. patent application Ser. No. 10/618,115, filed Jul. 10, 2003, discloses various alternatives for optically detectable marks on an optical storage medium, and is hereby incorporated by reference.

Note that for reading auxiliary information on the exterior surface, it may not be necessary to focus the lens on the external surface. Auxiliary information (symbols or data marks) on the external surface may be much larger than data marks on an interior data surface, so that it may be possible to read information on the external surface even if it is out of focus.

Auxiliary information, or data specifying a requirement for auxiliary information, may also be present on an interior data surface. Auxiliary information, or data specifying a requirement for auxiliary information, may be part of the recorded or embossed user data, or may be encoded within the recorded or embossed user data, or may reside in control data structures, or may be encoded into physical properties of an interior surface of the medium, such as groove wobble. For example, one way in which first data can be encoded within second data is to encode data within properties of error correction blocks. For example, see U.S. Pat. Nos. 6,064,748 and 6,278,386, which are hereby incorporated by reference. One example way in which data may reside in a control data structure is data within a control block. See, for example, U.S. Pat. No. 6,330,210, which is hereby incorporated by reference. A 2-bit field in a control block may be used to specify the requirement for auxiliary data, and which surface. Alternatively, for example, some optical disk media have grooves and lands, with data encoded into a sinusoidal radial variation in the grooves. For example, some embossed DVD media encode data block addresses in groove wobble, called Address In Pre-groove (ADIP). Data in one interior data surface may specify auxiliary data encoded in groove wobble in a different interior data surface. For example, data on an interior data surface might specify auxiliary data encoded in groove wobble that would be present only in embossed data layers from entertainment content providers. Writeable media would not have the required auxiliary data encoded in groove wobble, and accordingly the entertainment data would not be readable from a writeable medium.

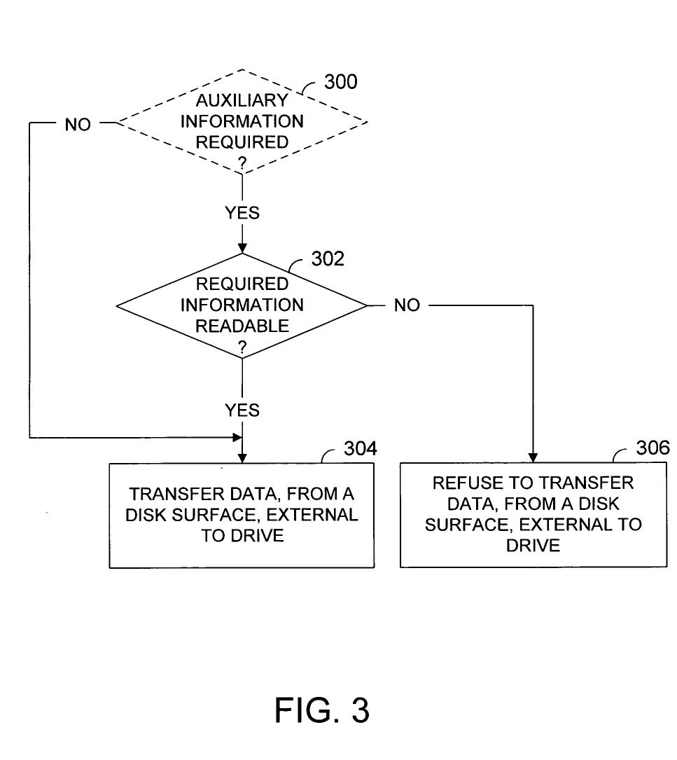

FIG. 3 illustrates an example method. In step 300, a drive determines whether auxiliary information is required before information from a specified surface can be transferred. Step 300 may not be required as an explicit separate method step, since the requirement for auxiliary information may come from something other than a medium. For example, the requirement for auxiliary information may be specified as part of a standard for all media. At step 302, if the required auxiliary information is readable by the drive, then at step 304 the drive transfers data, from a disk surface, external to the drive. At step 302, if required auxiliary information is not readable by the drive, then at step 306 the drive refuses to transfer data, from the disk surface, externally to the drive.

Note that data transferred externally from the drive may be analog information. For example, for a consumer entertainment medium, the drive output signal may be analog audio or video. For such a medium, the drive may refuse to provide an analog output signal unless required auxiliary information can be read from one surface of the medium.

1. A method, comprising:
refusing, by a drive, to provide information from a first surface of an optical medium when required information on a second surface of the optical medium cannot be read.

2. The method of claim 1, further comprising:
reading, from the first surface, information that indicates that information on the second surface is required.

3. The method of claim 1, further comprising:
refusing, by the drive, to provide information from a data surface of the optical medium when required information on an external surface of the optical medium cannot be read.

4. The method of claim 1, further comprising:
refusing, by the drive, to provide information from a first data surface of the optical medium when required information on a second data surface of the optical medium cannot be read.

5. An optical medium, comprising:
a first surface, the first surface having an indication that information on a second surface is required; and
information on the second surface corresponding to the indication on the first surface.

6. The optical medium of claim 5, further comprising:
the first surface being an internal data surface; and
the second surface being an external surface.

7. The optical medium of claim 5, further comprising:
the first surface being an external surface; and
the second surface being an internal data surface.

8. The optical medium of claim 5, further comprising:
each of the first surface and the second surface being an internal data surface.

9. The optical medium of claim 5, further comprising:
the information on the second surface comprising a bar code.

10. The optical medium of claim 5, further comprising:
the information on at least one of the first and second surfaces comprising data in a control block.

11. The optical medium of claim 5, further comprising:
the information on at least one of the first and second surfaces comprising data encoded in groove wobble.

12. The optical medium of claim 5, further comprising:
the information on at least one of the first and second surfaces comprising data embedded within other data.

13. The optical medium of claim 5, further comprising:
the information on the second surface comprising variable information.

14. The optical medium of claim 13, further comprising:
the information on the second surface comprising a unique identifier of the optical medium.

15. A drive for optical media, comprising:
a controller, the controller transferring, externally to the drive, information from a first surface on an optical medium, only when required information can be read on a second surface on the optical medium.

16. A drive for optical media, comprising:
means for detecting that information on a first surface of an optical medium is required; and
means for refusing to transfer information, externally to the drive, from a second surface of the optical medium, unless the required information on the first surface can be read by the drive.
